(19) United States
(12) Patent Application Publication
(10) Pub. No.: US 2020/0148905 A1
(43) Pub. Date: May 14, 2020

(54) PRINTABLE DIELECTRIC MIXTURE AND USE AND MANUFACTURE

(71) Applicant: University of Massachusetts, Boston, MA (US)

(72) Inventors: Oshadha K. Ranasingha, Salem, NH (US); Mahdi Haghzadeh, Lowell, MA (US); Alkim Akyurtlu, Arlington, MA (US); Craig A. Armiento, Acton, MA (US)

(21) Appl. No.: 16/184,796

(22) Filed: Nov. 8, 2018

(51) Int. Cl. C09D 11/322; C09D 11/36; C09D 11/037; C09D 11/033; C09D 11/106

(52) U.S. Cl. CPC C09D 11/322; C09D 11/36; H01G 7/06; C09D 11/033; C09D 11/106; C09D 11/037

(57) ABSTRACT

This disclosure describes manufacture of mixture and use of same to fabricate a respective electronic device. In one embodiment, the mixture includes: perovskite oxide particles and a solvent. The solvent is a water-soluble liquid such as ethylene glycol. A combination of the perovskite oxide particles and the solvent are mixed for subsequent fabrication (such as via a printing head of a printer) of an electronic device.

### RELATED APPLICATIONS

This application is related to earlier filed U.S. patent application Ser. No. 15/203,706 entitled “FERROELECTRIC NANOCOMPOSITE BASED DIELECTRIC INKS FOR RECONFIGURABLE RF AND MICROWAVE APPLICATIONS,” filed on Apr. 17, 2017, the entire teachings of which are incorporated herein by this reference.

Any material, or portion of the above incorporated patent application is only incorporated to the extent that no conflict arises between that incorporated material and the present disclosure material. In the event of a conflict, the conflict is to be resolved in favor of the present disclosure as the preferred disclosure.

### JOINT RESEARCH AGREEMENT

This invention resulted from work under a joint research agreement between the University of Massachusetts Lowell and the Raytheon Company.

### BACKGROUND

Conventional electronic devices can be printed on a substrate using print techniques as described in U.S. Patent Publication 2017/0009090. For example, this cited patent publication describes a ferroelectric ink comprising multiphase Barium Strontium Titanate (BST) in a polymer composite is described. This conventional ink can be employed using direct-ink writing techniques to print high dielectric constant, low loss, and electrostatically-tunable dielectrics on substrates.

### BRIEF DESCRIPTION OF EMBODIMENTS

In contrast to conventional inks, embodiments herein include novel printable formulas facilitating the manufacture of higher performance electronic devices.

More specifically, in one example embodiment, a mixture includes: perovskite oxide particles and a solvent. The solvent is a water-soluble liquid. A combination of the perovskite oxide particles and the solvent is pre-mixed and flowable for subsequent fabrication (such as via a printing head of a printer) of an electronic device.

In one embodiment, the perovskite oxide particles in the mixture are particles such as Barium Strontium Titanate (BST) particles, although any suitable particles can be used in the mixture. The ratio of Barium : Strontium can vary from 0:1 to 1:0.

In accordance with further embodiments, the particles are nanoparticles that are fairly uniform in shape and size. Alternatively, the mixture may include particles of different sizes and shapes. Note that further embodiments herein include producing the mixture to include doped BST nanoparticles. In one embodiment, the particles are Zirconia doped BST nanoparticles. In such an instance, the resulting compound is a Zirconia doped BST ink. Note that the BST particles can be doped with any suitable material.

In accordance with further embodiments, the solvent included in the mixture (such as printable ink) is selected from the glycol family of solvents. In one embodiment, the solvent is Ethylene Glycol. The perovskite oxide particles are suspended in the solvent.

In accordance with further embodiments, a ratio of the solvent to the perovskite oxide particles is controlled such that the mixture has a viscosity of between 20 and 6000 cP (centipoise). Further embodiments herein include fabricating viscosities of dielectric ink of up to 20,000-25,000 cP.

By way of further non-limiting example embodiment, the mixture is used as a printable ink in a printing device to fabricate the electronic device. Attributes (makeup of the mixture and ratios of components) can be controlled to facilitate application of the mixture (such as printable ink) in different ways. For example, different mixtures as described herein can be applied via dispensing, aerosol jet, inkjet, spin coating, etc., depending on the makeup of the mixtures. Embodiments herein include controlling ratios of material (components) included in the mixture to support different types of printing technology and applications.

In accordance with further embodiments, the mixture includes a dispersant operable to disperse the perovskite oxide particles in the mixture. By way of non-limiting example embodiment, the dispersant includes Ammonium Polymethacrylate (such as a commercial dispersant by the name NanoSperse S™), which comprises a portion of ammonium polymethacrylate (such as 25% by weight) and a portion of water (such as 75% by weight).

In accordance with still further embodiments, the mixture includes a water-soluble polymer material such as polyvinyl alcohol. The mixture 152 can be produced to further include polyvinylpyrrolidone (a.k.a., PVD in this disclosure).

Further embodiments herein include including one or more additives in the mixtures to control its properties. For example, additives selectively included in the mixture (dielectric ink) include components such as: 1-heptane, alpha-terpineol, ethyl cellulose, glycerol, etc. Amounts of the additive may vary depending on the embodiment. In one embodiment, the mixture is fabricated to include up to 5% of one or more of the additives.

The mixture also can include one or more nonaqueous solvents and a polymer dissolvable in the one or more nonaqueous solvents.

In accordance with still further embodiments, the mixture includes a first solvent and a second solvent. In one embodiment, the second solvent is a water-soluble polymer material dissolved in water.

Further embodiments herein controlling a viscosity of the mixture (such as liquid, printable ink). This can be achieved by controlling or adjusting a ratio of solvents included in the mixture.

For example, in one embodiment, in which PVA (PolyVinyl Alcohol) material is absent from the mixture, a manufacturer includes ethylene glycol and 1-methoxy-2-propanol in the mixture. The manufacturer controls a viscosity of the mixture based on a solvent ratio of ethylene glycol (having a viscosity of 16 cP) and 1-methoxy-2-propanol (having a viscosity of 1.7 cP) included in the mixture. In other words, the fabricator resource controls or adjusts a solvent ratio of these two solvents (such as ethylene glycol and 1-methoxy-2-propanol) in the mixture to obtain a desired viscosity for the mixture.

As previously discussed, the mixture can include a PVA material. For such a mixture that includes a PVA polymer, the manufacturing resource includes solvents ethylene glycol (having a viscosity of around 16 cP) and water (having a viscosity of around 0.9 cP) in the mixture. In one embodiment, manufacturing resource controls a ratio of the ethylene glycol to water in the mixture to obtain a desired overall viscosity of the mixture.

Further embodiments herein include an apparatus (such as hardware, device, etc.) comprising: an electronic device being fabricated; and a mixture (such as a compound) applied to fabricate the electronic device. The mixture comprises: i) perovskite oxide particles, and ii) a solvent, the solvent being a water-soluble liquid.

In accordance with further embodiments, the apparatus includes a substrate on which the liquid material is applied. The substrate is an electrically conductive structure in which to apply a voltage and control operation of the electronic device.

In accordance with further embodiments, the mixture (compound) applied to fabricate the electronic device cures into a dielectric material on the substrate of the electronic device being fabricated. A dielectric constant of the cured dielectric material on the substrate varies depending on application of a voltage applied to the substrate. In one embodiment, a magnitude of the dielectric constant varies by 15% at an applied external electric field strength of 10 V/μm. In one embodiment, the variation of the dielectric constant for temperatures between −50° C. and 125° C. is around 11%. Based on the composition of the mixture, the dielectric constant of the cured dielectric material as described herein is substantially constant for application of frequencies between 2 GHz and 12 GHz.

In one embodiment, the mixture has a curing temperature below 170 degrees Celcius, although this can vary depending on the embodiment.

Note that the substrate or base material on which the mixture is applied can be any suitable material. For example, in one embodiment, the substrate on which the mixture is applied is a material such as metal, dielectric material, etc.

Embodiments herein are useful over conventional printable ink. For example, the disclosed novel tunable ferroelectric ink (including BST particles) can be used in various applications such as fully printed phase shifters, fully printed varactors (variable capacitors) and frequency selective surfaces (FSS). The dielectric constant of the novel BST ink as described herein is stable at higher frequencies (between 2 GHz-12 GHz) and useful in microwave and RF applications. Additionally, the BST ink as described herein can be used in other applications which need a high dielectric constant. In this formulation, it is not necessary to sinter the BST nanoparticles to get tunability. The low curing temperature (200 degree Celcius) allows for use with a wide range of substrates including some flexible substrates. As described herein, different formulas of this BST ink can be used in several printing technologies such as dispensing, aerosol jet, ink jet etc.

These and other more specific embodiments are disclosed in more detail below.

Note that any of the resources as discussed herein such as a fabricator (fabrication facility) can include one or more computerized devices, workstations, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium or hardware storage media disparately or co-located) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage media such as an optical medium (e.g., CD-ROM), floppy disk, hard disk, memory stick, memory device, etc., or other a medium such as firmware in one or more ROM, RAM, PROM, etc., and/or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations such as fabrication of one or more optical devices as discussed herein.

Further embodiments herein include a computer readable storage media and/or a system having instructions stored thereon to facilitate fabrication of one or more mixtures and corresponding electronic devices as discussed herein. For example, in one embodiment, the instructions, when executed by computer processor hardware, cause the computer processor hardware (such as one or more processor devices) associated with a fabricator to: receive perovskite oxide particles; receive a solvent, the solvent being a water-soluble liquid; and produce a printable mixture (or compound) including the perovskite oxide particles and the solvent for subsequent fabrication of an electronic device.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the method as discussed herein also can be embodied strictly as a software program, firmware, as a hybrid of software, hardware and/or firmware, or as hardware alone such as within a processor (hardware or software), or within an operating system or a within a software application.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram illustrating manufacture of a printable mixture and use of the printable mixture to fabricate electronic devices according to embodiments herein.

FIG. 2 is an example diagram illustrating control information to manufacture a printable mixture according to embodiments herein.

FIG. 3 is an example diagram illustrating manufacture of a printable mixture and use of the printable mixture to fabricate electronic devices according to embodiments herein.

FIG. 4 is an example diagram illustrating control information to manufacture a printable mixture according to embodiments herein.

FIG. 5 is an example diagram illustrating a single stage manufacture process to produce a printable mixture and use of the printable mixture to fabricate electronic devices according to embodiments herein.

FIG. 6A is an example diagram illustrating fabrication of an electronic device using a novel liquid mixture according to embodiments herein.

FIG. 6B is an example diagram illustrating fabrication of an electronic device using a novel liquid mixture according to embodiments herein.

FIG. 6C is an example diagram illustrating a cutaway view of the electronic device in FIG. 6B according to embodiments herein.

FIG. 7 is an example diagram illustrating fabrication of an electronic device using a novel liquid mixture according to embodiments herein.

FIG. 8 is an example diagram illustrating fabrication of an electronic device using a novel liquid mixture according to embodiments herein.

FIG. 9 is a diagram illustrating example computer architecture associated with a fabrication facility to execute any operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

The tunable ferroelectric ink (mixture) as described herein can be used in various applications such as fully printed phase shifters, fully printed varactors (variable capacitors) Frequency Selective Surfaces (FSS), conformal antennas, phased array antennas, etc. The stable dielectric constant of the cured dielectric ink at higher frequency (such as between 2 GHz and 12 GHz) is useful for microwave and RF applications. Such BST ink (mixture) can be used in other applications as well such as those requiring a material having a high dielectric constant.

According to embodiments herein, it is not necessary to sinter the BST nanoparticles in the ink to achieve tunability. The low curing temperature (such as around 150-200 degree Celsius) allows for use with a wide range of substrates including some flexible substrates. The different BST ink formulas as described herein be used in several printing technologies such as dispensing, aerosol jet printing, ink jet printing, etc.

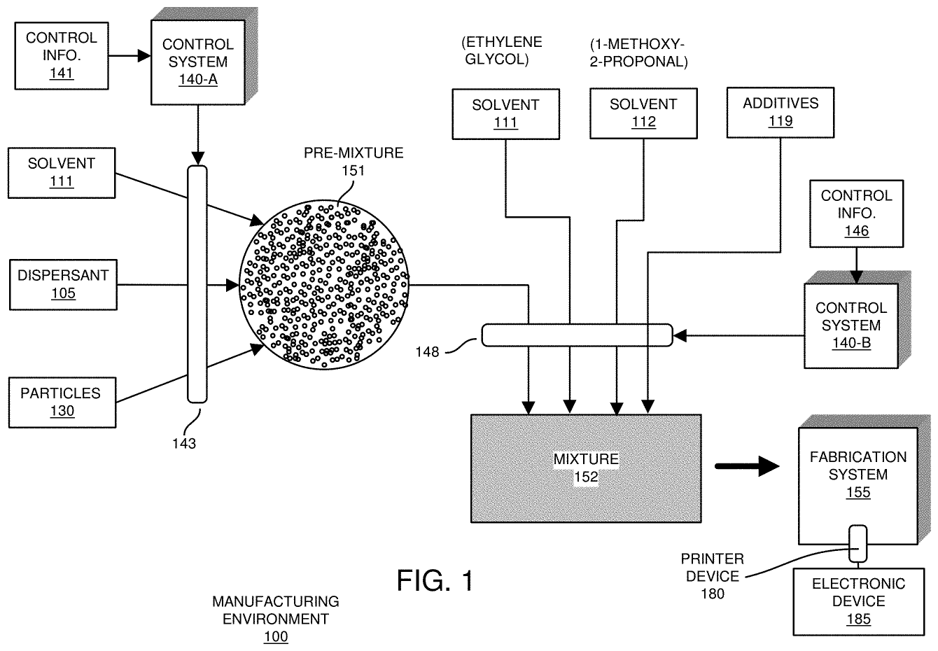

FIG. 1 is an example diagram illustrating manufacture and use of a liquid mixture according to embodiments herein.

As shown, manufacturing environment 100 includes control system 140 (two stages such as control system 140-A and control system 140-B) and fabrication system 155.

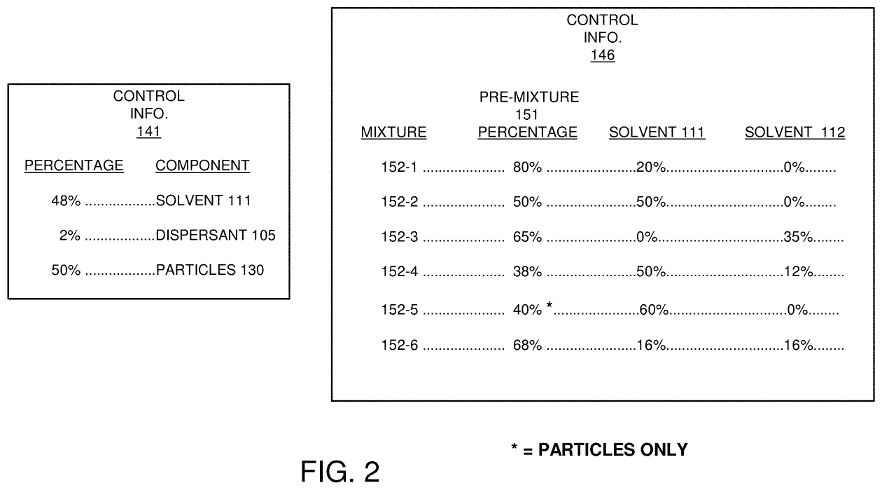

In a first fabrication stage of manufacturing environment 100, via control information 141 (see example of component ratios in FIG. 2), the control system 140-A produces pre-mixture 151 based on a combination of material such as solvent 111, dispersant 105, particles 130.

In accordance with further embodiments, the solvent 111 in the mixture 152 (such as printable dielectric ink) is water-soluble. In one embodiment, the solvent 111 is selected from the glycol family of solvents. In a specific embodiment, the solvent 111 is Ethylene Glycol. As its name suggests, the dispersant 105 disperses the perovskite oxide particles in the pre-mixture 151. In one embodiment, the dispersant 105 is or includes Ammonium Polymethacrylate (such as a commercial dispersant by the name NanoSperse S™), which comprises a portion of ammonium polymethacrylate (such as 25% by weight) and a portion of water (such as 75% by weight), although these ratios may vary.

Any suitable type of particles can be used to fabricate the pre-mixture 151. For example, in one embodiment, the particles 130 are perovskite oxide particles (such as Barium Strontium Titanate particles). The particles 130 may be sintered or non-sintered.

In accordance with further embodiments, the particles 130 are nanoparticles of uniform shape and size. Alternatively, the mixture may include particles 130 of different sizes and shapes.

According to further embodiments, the particles 130 have a size distribution with a modal size in the range of 30 nanometers to 2000 nanometers, although the mixture may include particles 130 of any suitable size as previously mentioned.

Note further that the particles 130 can be doped BST particles. In such an instance, the control system 140 produces the pre-mixture 151 to include doped BST nanoparticles.

In accordance with further embodiments, in the second stage of the manufacturing environment, the control system 140-B controls a ratio of the one or more solvents (such as solvent 111 and/or solvent 112) and pre-mixture 151 such that the final mixture 152 has a viscosity of between 20 and 6000 cP. Further embodiments herein include fabricating dielectric ink to have viscosities of up to 20,000-25,000 cP. Thus, embodiments herein include controlling ratios of components (such as solvents, pre-mixture 151, etc.) to produce a mixture 152 of desirable viscosity.

As a more specific example in which PVA (Polyvinyl Alcohol) material is absent from the mixture 152, the control system 140 includes solvent 111 such as ethylene glycol and solvent 112 such as 1-methoxy-2-propanol in the mixture 152. The manufacturer controls a viscosity of the mixture 152 based on a ratio of solvent ethylene glycol (having a viscosity of 16 cP) and solvent 1-methoxy-2-propanol (having a viscosity of 1.7 cP) included in the mixture 152.

In one embodiment, the control system 140 controls or adjusts a solvent ratio of these two solvents (such as ethylene glycol and 1-methoxy-2-propanol) in the mixture 152 to obtain a desired viscosity for subsequent fabrication of an electronic device 185.

To produce the final mixture 152 (such as a compound of printable dielectric liquid ink), in accordance with control information 146 (see example of component ratios in FIG. 2), the control system 140-B combines portions of the pre-mixture 151, solvent 111, and solvent 112.

Further embodiments herein include including one or more additives 119 in the mixture 152 to further control its properties. For example, in one embodiment the control system 140-B controls inclusion of one or more additives 119 in the mixture 152 (dielectric ink). Available additives 119 include material such as: 1-heptane, alpha-terpineol, ethyl cellulose, glycerol, etc.

Amounts of the additives 119 included in mixture 152 vary depending on the embodiment. In one embodiment, the mixture 152 is fabricated to include up to 5% (such as by weight) of one or more of the additives. In other embodiments, the control system 140-B produces the mixture 152 such that less than 1% (such as by weight) of the final mixture 152 is made up of one or more additives 119. As further shown in FIG. 1, fabrication system 155 receives and uses the final mixture 152 to fabricate the electronic device 185. In one embodiment, the fabrication system 155 includes a printer device 182 to control application of the mixture 152 (such as a printable ink) and, thus, fabrication of the electronic device 185.

As further discussed herein, note that the quantity of components (such as amount/ratio of solvents, particles 130, etc.) can be controlled to facilitate application of the mixture 152 (such as printable ink) in different ways. For example, as further discussed below, different mixtures as described herein can be applied via dispensing, aerosol jet, inkjet, etc., depending on the makeup of the respective mixture 152. Thus, embodiments herein include controlling ratios of material (components) included in the mixture to support different types of printing technology and applications.

FIG. 2 is an example diagram illustrating control information (formulas) to manufacture different liquid mixtures according to embodiments herein.

For example, with reference to both FIG. 1 and FIG. 2, the control system 140-A uses the control information 141 to identify a ratio/quantity of different components (such as solvent 111, dispersant 105, and particles 132) that are combined to produce the pre-mixture 151.

As previously discussed, in one embodiment, the solvent 111 is ethylene glycol (which is water-miscible); the solvent 112 is 1-Methoxy-2-Propanol (which is flammable).

In the first manufacturing stage, the control system 140-A controls manufacturing resources 143 (such as valves, conveyors, mixing equipment, agitator equipment, measuring equipment, human labor, etc.) to mix the appropriate amount of the different components (such as solvent 111, dispersant 105, and particles 130) to produce pre-mixture 151.

In one embodiment, as shown by control information 141, the control system 140-A can be configured to produce the pre-mixture 151 using 48% by weight of solvent 111, 2% by weight of dispersant 105, and 50% by weight of particles 130. The ratio of these components (such as solvent 111, dispersant 105, and particles 130) can vary depending on the embodiment.

In accordance with yet further embodiments, the pre-mixture 151 is a slurry subsequently used to manufacture the final mixture 152. For example, control system 140-B uses control information 146 to manufacture one of multiple different mixtures 152-1, 152-2, 152-3, 152-4, 152-5, or 152-6 via control of manufacturing resources 148 (such as valves, conveyors, mixing equipment, agitator equipment, measuring equipment, etc.). Thus, to some extent, the control information 146 includes multiple recipes (ratios of different components) to produce different types of mixtures.

As further discussed below, the control system 140 combines appropriate amounts of one or more solvents to a selected amount of the pre-mixture 151 to produce printable inks (such as mixture 152-1, 152-2, 152-3, etc.) having different properties.

More specifically, to produce the mixture 152-1, as shown by control information 146, the control system 140-B controls manufacturing resources 148 to produce the mixture 152-1 using (such as mixing) 80% by weight of the pre-mixture 151 and 20% by weight of the solvent 111 (such as ethylene glycol). Fabrication system 155 implements any suitable printing technology such as dispensing of the mixture 152-1 through printer device 180 to produce the electronic device 185.

As another example, to produce mixture 152-2, as shown by control information 146, the control system 140-B controls manufacturing resources 148 to produce the mixture 152-2 using (such as mixing) 50% by weight of the pre-mixture 151 and 50% by weight of the solvent 111 (such as ethylene glycol). Fabrication system 155 implements any suitable printing technology such as dispensing of the mixture 152-1 through printer device 180 to produce the electronic device 185.

As yet another example, to produce mixture 152-3, as shown by control information 146, the control system 140-B controls manufacturing resources 148 to produce the mixture 152-3 using (such as mixing) 65% by weight of the pre-mixture 151 and 35% by weight of the solvent 112 (such as 1-Methoxy-2-Propanol). Fabrication system 155 implements any suitable printing technology such as dispensing of the mixture 152-3 through printer device 180 to produce the electronic device 185.

As a further example, to produce mixture 152-4, as shown by control information 146, the control system 140-B controls manufacturing resources 148 to produce the mixture 152-4 using (such as mixing) 38% by weight of the pre-mixture 151, 50% by weight of the solvent 111 (such as ethylene glycol), and 12% by weight of the solvent 112 (such as 1-Methoxy-2-Propanol). Fabrication system 155 implements any suitable printing technology such as aerosol jet or inkjet printing of the mixture 152-3 via printer device 180 to produce the electronic device 185.

As another example, to produce mixture 152-5, as shown by control information 146, the control system 140-B controls manufacturing resources 148 to produce the mixture 152-2 using (such as mixing) 40% by weight of the particles 130 (such as BST powder only) and 60% by weight of the solvent 111 (such as ethylene glycol). Fabrication system 155 implements any suitable printing technology such as dispensing of the mixture 152-1 through printer device 180 to produce the electronic device 185.

As a further example, to produce mixture 152-6, as shown by control information 146, the control system 140-B controls manufacturing resources 148 to produce the mixture 152-4 using (such as mixing) 68% by weight of the pre-mixture 151, 16% by weight of the solvent 111 (such as ethylene glycol), and 16% by weight of the solvent 112 (such as 1-Methoxy-2-Propanol). Fabrication system 155 implements any suitable printing technology such as aerosol jet or inkjet printing of the mixture 152-6 via printer device 180 to produce the electronic device 185.

In contrast to conventional BST inks, one or more of the mixtures as described herein supports dielectric material having a dielectric constant at 10 GHz of up to 45. The mixture can be fabricated to provide a dielectric material constant of between 3-45. Loss tangent of the dielectric material (cured mixture) at 10 GHz is less than 0.03. Tunability of the dielectric material at 10 GHz is 15% with applied external electric field strength of 10 Wm. Temperature sensitivity of the dielectric constant at 10 GHz is less than 11% between −50° C. and 100° C. In certain instances, the stability of mixture 152 (without a need for mixing to print) is greater than 6 months.

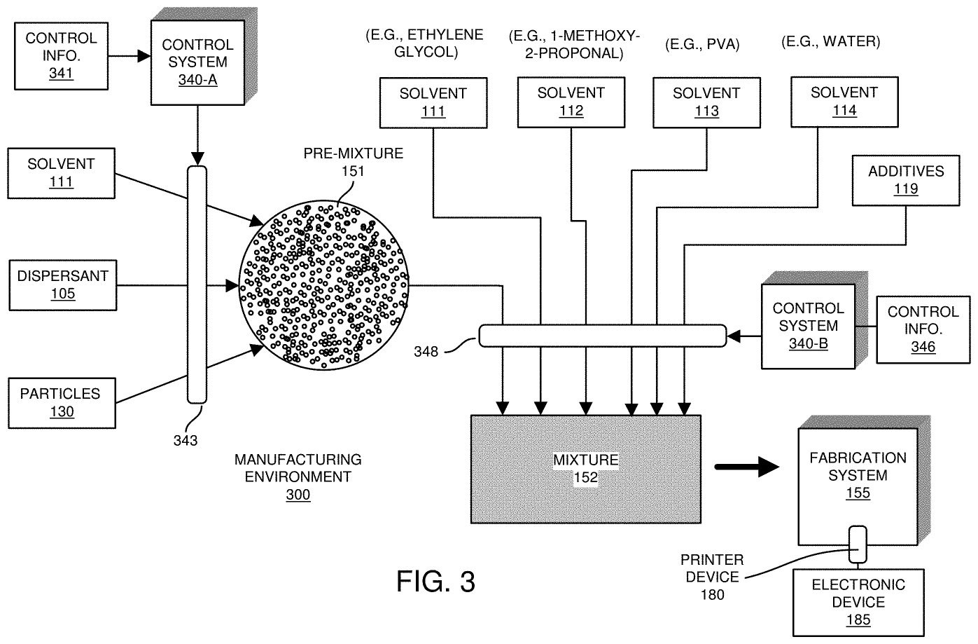

FIG. 3 is an example diagram illustrating multi-stage manufacture of a mixture and use of the liquid mixture to fabricate an electronic device according to embodiments herein.

As shown, manufacturing environment 300 includes control system 340 (two stages such as control system 340-A and control system 340-B) and fabrication system 155.

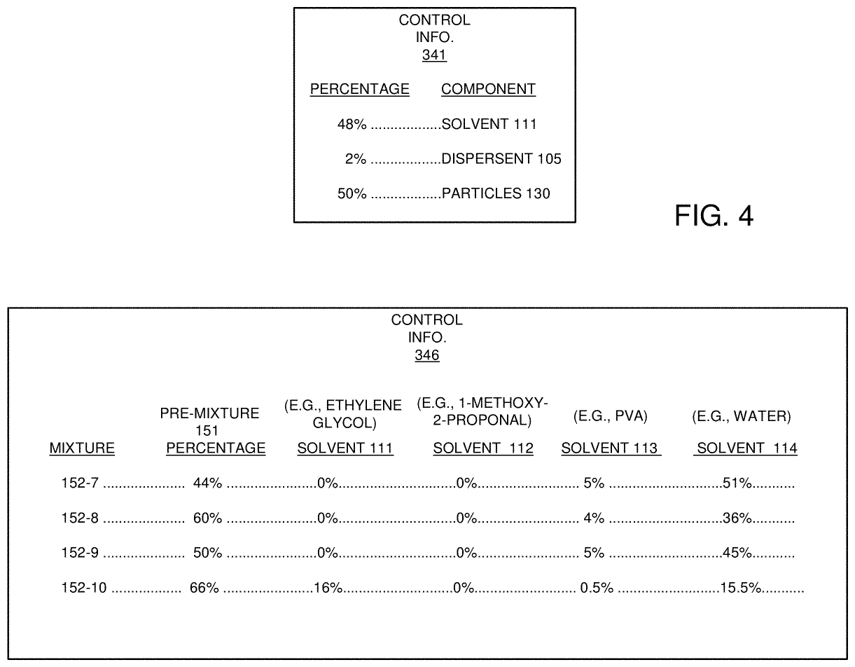

In a first fabrication stage of manufacturing environment 300, via control information 341 (see example of component ratios in FIG. 4), the control system 340-A produces pre-mixture 151 based on a combination of material such as solvent 111, dispersant 105, particles 130.

In this example embodiment, the solvent 111 in the mixture 152 (such as printable dielectric ink) is water-soluble. The solvent 111 is selected from the glycol family of solvents. In a specific embodiment, the solvent 111 is Ethylene Glycol.

The dispersant 105 disperses the perovskite oxide particles in the pre-mixture 151. In one embodiment, the dispersant 105 is or includes Ammonium Polymethacrylate (such as a commercial dispersant by the name NanoSperse S™) which comprises a portion of ammonium polymethacrylate (such as 25% by weight) and a portion of water (such as 75% by weight), although these ratios may vary.

Any suitable type of particles can be used to fabricate the pre-mixture 151. For example, in one embodiment, the particles 130 are perovskite oxide particles (such as Barium Strontium Titanate particles). The particles 130 may be sintered or non-sintered.

In accordance with further embodiments, the particles 130 are nanoparticles of uniform shape and size. Alternatively, the mixture may include particles 130 of different sizes and shapes.

Note further that the particles 130 can be doped BST particles. In such an instance, the control system 340 produces the pre-mixture 151 to include doped BST nanoparticles.

To produce the final mixture 152 (such as a compound of printable dielectric liquid ink), in accordance with control information 346 (see example of component ratios in FIG. 4), the control system 340-B combines portions of the pre-mixture 151, solvent 111, solvent 112, solvent 113, and/or solvent 114.

Further embodiments herein include including one or more additives 119 in the mixture 152 to further control its properties. For example, in one embodiment the control system 340-B controls inclusion of one or more additives 119 in the mixture 152 (dielectric ink). Available additives 119 include material such as: 1-heptane, alpha-terpineol, ethyl cellulose, glycerol, etc.

Amounts of the additives 119 included in mixture 152 vary depending on the embodiment. In one embodiment, the mixture 152 is fabricated to include up to 5% (such as by weight) of one or more of the additives. In other embodiments, the control system 340-B produces the mixture 152 such that less than 1% (such as by weight) of the final mixture 152 is made up of one or more additives 119.

As further shown in FIG. 3, fabrication system 155 receives and uses the final mixture 152 to fabricate the electronic device 185. In one embodiment, the fabrication system 155 includes a printer device 182 to control application of the mixture 152 (such as a printable ink) and, thus, fabrication of the electronic device 185.

In certain instances, the mixture 152 as described herein is useful as no component in the mixture evaporates at room temperature. The mixture 152 is non-flammable.

As further discussed herein, note that the quantity of components (such as amount/ratio of solvents, particles 130, etc.) can be controlled to facilitate application of the mixture 152 (such as printable ink) in different ways. For example, as further discussed below, different mixtures as described herein can be applied via dispensing, aerosol jet, inkjet, etc., depending on the makeup of the respective mixture 152. In one embodiment, the mixture 152 is spin coated onto a substrate to fabricate a respective electronic device. Thus, embodiments herein include controlling ratios of material (components) included in the mixture to support different types of printing/deposition technology and applications.

In accordance with further embodiments, note that the printer device 180 is a ball point pen filled with the mixture 152 (dielectric ink). In such an instance, the printer device 180 (pen) is manually used by a respective user to apply the ink to desired one or more regions of the electronic device 185 being fabricated.

FIG. 4 is an example diagram illustrating control information to manufacture a liquid mixture according to embodiments herein.

For example, with reference to both FIG. 3 and FIG. 4, the control system 340-A uses the control information 341 to identify a ratio/quantity (formula) of different components (such as solvent 111, dispersant 105, and particles 130) that are combined to produce the pre-mixture 151.

As previously discussed, in one embodiment, the solvent 111 is ethylene glycol (which is water soluble); the solvent 112 is 1-Methoxy-2-Propanol (which is flammable).

In the first manufacturing stage, the control system 340-A controls manufacturing resources 343 (such as valves, conveyors, mixing equipment, etc.) to mix the appropriate amount of the different components (such as solvent 111, dispersant 105, and particles 130) to produce pre-mixture 151.

In one embodiment, as shown by control information 341, the control system 340-A can be configured to produce the pre-mixture 151 using 48% by weight of solvent 111, 2% by weight of dispersant 105, and 50% by weight of particles 130. The ratio of these components (such as solvent 111, dispersant 105, and particles 130) varies depending on the embodiment.

In accordance with yet further embodiments, the pre-mixture 151 is a slurry subsequently used to manufacture the final mixture 152.

For example, control system 340-B uses control information 346 to manufacture one of multiple different mixtures 152-1, 152-2, 152-3, 152-4, 152-5, or 152-6 via control of manufacturing resources 148 (such as valves, conveyors, mixing equipment, etc.). Thus, the control information 346 includes multiple formulas (ratios of different components) to produce different types of mixtures.

As further discussed below, the control system 140 combines appropriate amounts of one or more solvents to a selected amount the pre-mixture 151 to produce printable ink having different properties.

More specifically, to produce the mixture 152-7, as shown by control information 346, the control system 340-B controls manufacturing resources 348 to produce the mixture 152-7 using (such as mixing) 44% by weight of the pre-mixture 151, 5% by weight of solvent 113 (such as Polyvinyl Alcohol), and 51% by weight of the solvent 114 (such as water). Fabrication system 155 implements any suitable printing technology such as dispensing of the mixture 152-7 through printer device 180 to produce the electronic device 185.

As another example, to produce the mixture 152-8, as shown by control information 346, the control system 340-B controls manufacturing resources 348 to produce the mixture 152-8 using (such as mixing) 60% by weight of the pre-mixture 151, 4% by weight of solvent 113 (such as Polyvinyl Alcohol), and 36% by weight of the solvent 114 (such as water). Fabrication system 155 implements any suitable printing technology such as dispensing of the mixture 152-8 through printer device 180 to produce the electronic device 185.

As another example, to produce the mixture 152-9, as shown by control information 346, the control system 340-B controls manufacturing resources 348 to produce the mixture 152-9 using (such as mixing) 50% by weight of the pre-mixture 151, 5% by weight of solvent 113 (such as Polyvinyl Alcohol), and 45% by weight of the solvent 114 (such as water). Fabrication system 155 implements any suitable printing technology such as dispensing of the mixture 152-9 through printer device 180 to produce the electronic device 185.

As another example, to produce the mixture 152-10, as shown by control information 346, the control system 340-B controls manufacturing resources 348 to produce the mixture 152-10 using (such as mixing) 66% by weight of the pre-mixture 151, 16% by weight of solvent 111, 0.5% by weight of solvent 113 (such as Polyvinyl Alcohol), and 15.5% by weight of the solvent 114 (such as water). Fabrication system 155 implements any suitable printing technology such as dispensing of the mixture 152-10 through printer device 180 to produce the electronic device 185.

As previously discussed, the mixture 152 can include a PVA material. For such a mixture that includes a PVA polymer, the mixture is fabricated to include solvents ethylene glycol (having a viscosity of around 16 cP) and water (having a viscosity of around 0.9 cP). In one embodiment, manufacturing resource controls a ratio of the ethylene glycol to water (and/or other component ratios) in the mixture 152 to obtain a desired viscosity for printing and electronic device fabrication.

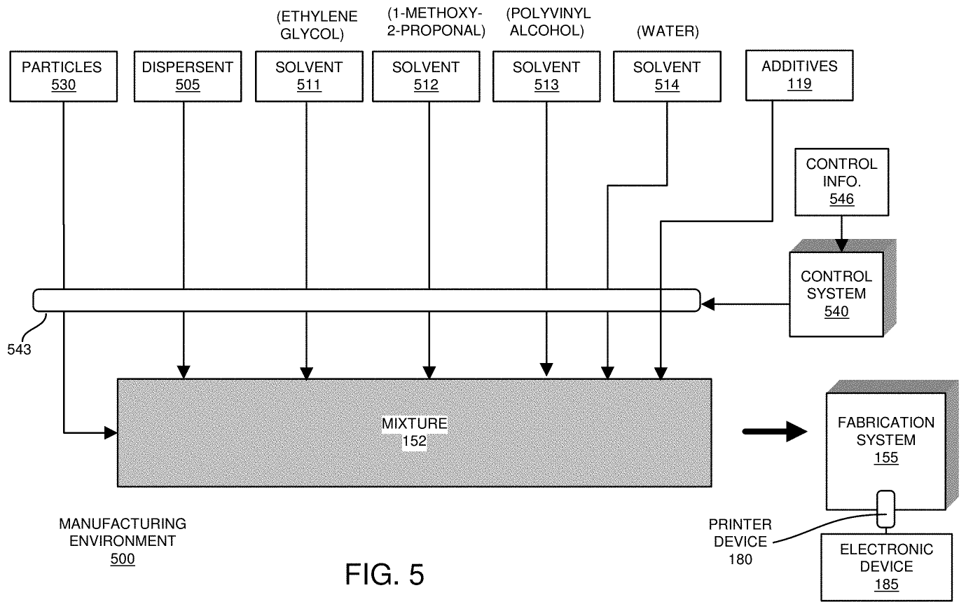

FIG. 5 is an example diagram illustrating a single stage manufacture of a mixture and use of the liquid mixture to fabricate a respective electronic device according to embodiments herein.

As an alternative to creating pre-mixture 151, using the pre-mixture 151 to produce the different mixtures 152, embodiments herein further include manufacturing environment 500 to include control system 540 and corresponding control information 546.

In this embodiment, via manufacturing resources 543 (such as valves, conveyors, mixing equipment, agitator equipment, measuring equipment, human labor, etc.), the control system 540 mixes appropriate quantities of different components such as (BST) particles 530, dispersant 505, solvent 511, solvent 512, solvent 513, and solvent 514 to produce mixture 152.

In one embodiment, to produce the mixture 152-1 in accordance with control information 546, the control system 540 mixes 58.4% by weight of solvent 111 (such as ethylene glycol), 1.6% by weight of dispersant 105, 40% by weight of particles 130, 0% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-2 in accordance with control information 546, the control system 540 mixes 74% by weight of solvent 111 (such as ethylene glycol), 1% by weight of dispersant 105, 25% by weight of particles 130, 0% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-3 in accordance with control information 546, the control system 540 mixes 31.2% by weight of solvent 111 (such as ethylene glycol), 1.3% by weight of dispersant 105, 32.5% by weight of particles 130, 35% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-4 in accordance with control information 546, the control system 540 mixes 68.24% by weight of solvent 111 (such as ethylene glycol), 0.76% by weight of dispersant 105, 19% by weight of particles 130, 12% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-5 in accordance with control information 546, the control system 540 mixes 60% by weight of solvent 111 (such as ethylene glycol), 0% by weight of dispersant 105, 40% by weight of particles 130, 0% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-6 in accordance with control information 546, the control system 540 mixes 48.64% by weight of solvent 111 (such as ethylene glycol), 1.36% by weight of dispersant 105, 34% by weight of particles 130, 16% of solvent 112 (such as 1-Methoxy-2-Propanol), 0% by weight of solvent 113 (such as polyvinyl alcohol), and 0% by weight of solvent 114 (such as water).

In one embodiment, to produce the mixture 152-7 in accordance with control information 546, the control system 540 mixes 21.12% by weight of solvent 111 (such as ethylene glycol), 0.88% by weight of dispersant 105, 22% by weight of particles 130, 0% of solvent 112 (such as 1-Methoxy-2-Propanol), 5% by weight of solvent 113 (such as polyvinyl alcohol), and 51% by weight of solvent 114 (such as water).

In one embodiment, to produce the mixture 152-8 in accordance with control information 546, the control system 540 mixes 28.8% by weight of solvent 111 (such as ethylene glycol), 1.2% by weight of dispersant 105, 30% by weight of particles 130, 0% of solvent 112 (such as 1-Methoxy-2-Propanol), 4% by weight of solvent 113 (such as polyvinyl alcohol), and 36% by weight of solvent 114 (such as water).

In one embodiment, to produce the mixture 152-9 in accordance with control information 546, the control system 540 mixes 24% by weight of solvent 111 (such as ethylene glycol), 1% by weight of dispersant 105, 25% by weight of particles 130, 0% of solvent 112 (such as 1-Methoxy-2-Propanol), 5% by weight of solvent 113 (such as polyvinyl alcohol), and 45% by weight of solvent 114 (such as water).

In one embodiment, to produce the mixture 152-10 in accordance with control information 546, the control system 540 mixes 31.68% by weight of solvent 111 (such as ethylene glycol), 1.32% by weight of dispersant 105, 33% by weight of particles 130, 0% of solvent 112 (such as 1-Methoxy-2-Propanol), 0.5% by weight of solvent 113 (such as polyvinyl alcohol), and 15.5% by weight of solvent 114 (such as water).

Further embodiments herein include including one or more additives 119 in the mixture 152 to further control its properties. For example, in one embodiment the control system 540 controls inclusion of one or more additives 119 in the mixture 152 (dielectric ink). Available additives 119 include material such as: 1-heptane, alpha-terpineol, ethyl cellulose, glycerol, etc.

Amounts of the additives 119 included in mixture 152 vary depending on the embodiment. In one embodiment, the mixture 152 is fabricated to include up to 5% (such as by weight) of one or more of the additives. In other embodiments, the control system 540 produces the mixture 152 such that less than 1% (such as by weight) of the final mixture 152 is made up of one or more additives 119.

In a similar manner as previously discussed, and as further shown in FIG. 5, fabrication system 155 receives and uses the final mixture 152 to fabricate the electronic device 185. In one embodiment, the fabrication system 155 includes a printer device 182 to control application of the mixture 152 (such as a printable ink) and, thus, fabrication of the electronic device 185.

In accordance with further embodiments, note that the printer device 180 is a ball point pen filled with the mixture 152 (dielectric ink). In such an instance, the printer device 180 (pen) is manually used by a respective user to apply the ink to desired one or more regions of the electronic device 185 being fabricated.

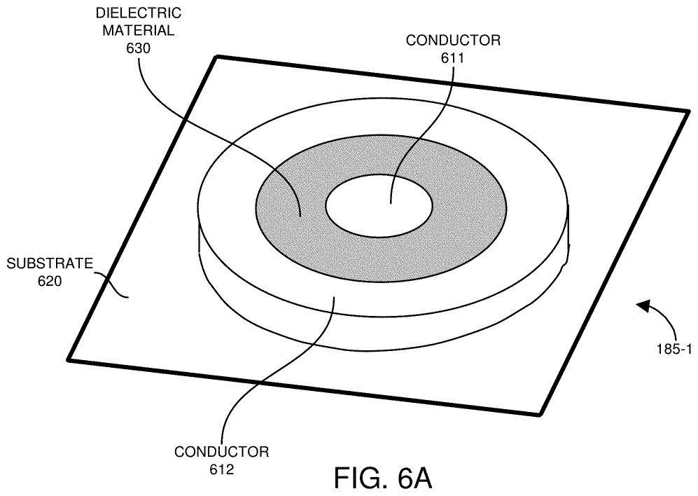

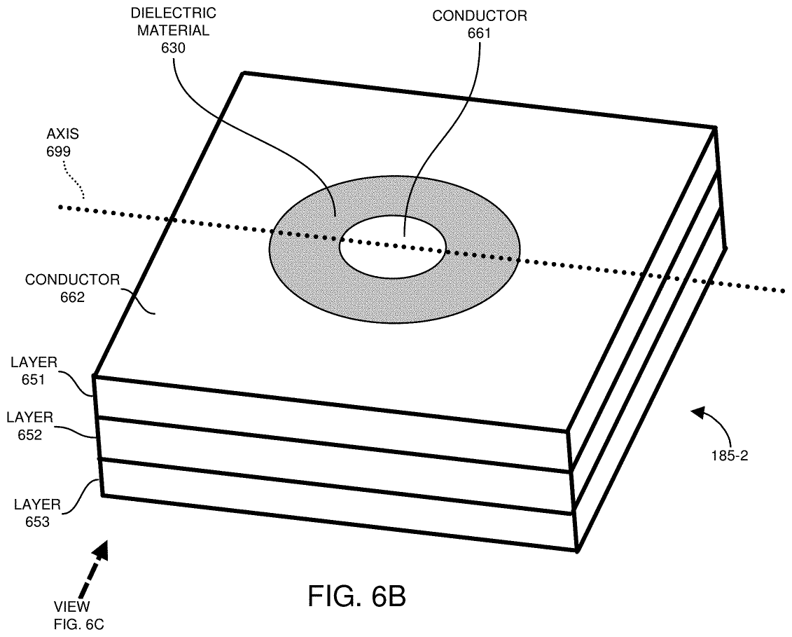

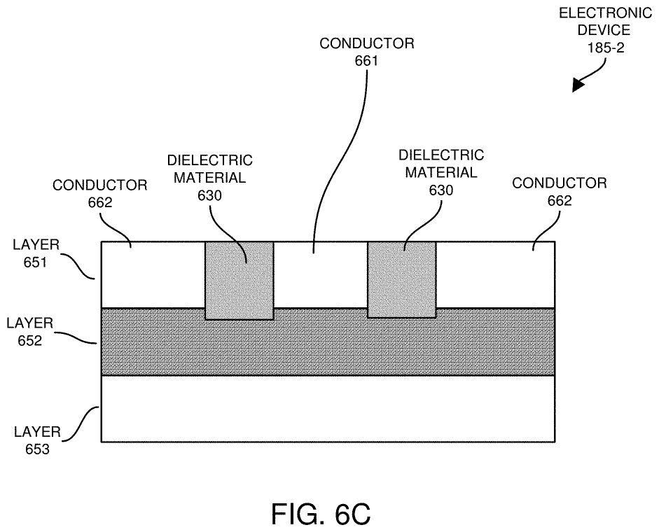

FIG. 6 is an example diagram illustrating fabrication of an electronic device using a novel liquid mixture according to embodiments herein.

In one embodiment, fabrication of an electronic device 185-1 such as a varactor includes receiving a substrate 620 upon which to make the varactor. In some embodiments, the substrate 620 can be a flexible substrate, such as a plastic sheet.

The substrate also can be a rigid substrate, such as a semiconductor wafer or a ceramic.

In an embodiment where the capacitor is going to be fabricated with both conductors 611 and 612 in the same plane, such as an interdigitated capacitor or a cylindrical capacitor, the conductors 611 and 612 are deposited on the substrate 620 and are patterned as required. Each conductor has an electrical terminal. As shown, the liquid BST ink (dielectric material 630) is deposited in the spaces between the conductors such as conductor 611 and conductor 612.

Note that any convenient method of depositing the liquid BST ink may be used, as previously described.

In accordance with further embodiments, an electrical field optionally can be applied between the two capacitor conductors 611 and 612 so as to pole or orient the BST particles in the liquid ink (mixture 152) prior to and/or during the curing of the mixture 152 into dielectric material 630. In one embodiment, the BST ink (mixture 152) is then cured by heating to a temperature of approximately 150° C.

A first varactor design is a printed cylindrical varactor on a substrate 620, where two concentric conductive cylinders 611 and 612 are fabricated by an additive manufacturing method. The dielectric material 630 (cured mixture 152) is filled in the cylindrical gap between the conductors (see FIG. 6). Such capacitors have a capacitance given by:

$$C = 2 {πɛ}_{0} {ɛ}_{r} \frac{h}{ln ( \frac{{R}_{out}}{{R}_{in}} )}$$

where Rout is the outside radius of the ink, Rin is the inside radius of the cured ink, h is the height (or thickness) of the cured ink (and of the electrodes), ϵᵣ is the complex permittivity, and ϵ₀ is the permittivity of free space. The capacitance equation can be manipulated to express the complex permittivity in terms of observable parameters and known constants as:

$${ɛ}_{r} = \frac{ln ( \frac{{R}_{out}}{{R}_{in}} )}{2 {πɛ}_{0} h} {C}_{D}$$

FIG. 6B is an example diagram illustrating an electronic device according to embodiments herein.

As shown, the example electronic device 185-2 includes multiple layers of material including layer 651, layer 652, and layer 653.

In one embodiment, each of the layer 651 and layer 653 is fabricated from material such as copper or some other suitable material. Layer 652 is a dielectric material such as an insulator.

To fabricate the electronic device 185-2 (such as a capacitor), embodiments herein include removing a portion (such as a disk region) of the layer 651 down to or including a portion of the layer 652. In one embodiment, the conductor 661 is cylinder in shape. The removed portion (such as a hollow disk) in layer 651 is then filled with dielectric material 630, which is initially mixture 152 that cures into a solid tunable, dielectric material.

Further embodiments herein include using conductor 651 as a first electrode of the electronic device 185-2 (such as connected to a driving signal) and using the conductor 662 as a second electrode (such as connected to ground) of the electronic device 185-2.

Axis 699 indicates a cutaway view for the following drawing (FIG. 6C).

FIG. 6C is an example diagram illustrating a side view of an electronic device according to embodiments herein.

As previously discussed, in this example embodiment, the cured dielectric material 630 forms a disk around conductor 661. The depth of the disk of dielectric material 630 extends to layer 652 or deeper as shown.

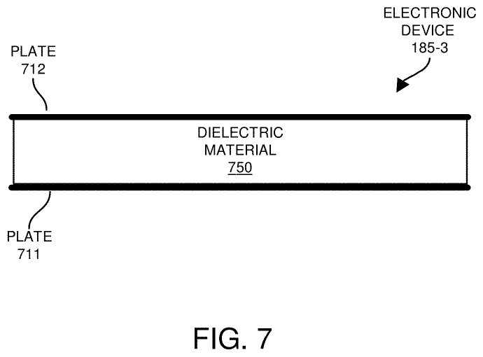

FIG. 7 is an example diagram illustrating fabrication of an electronic device using a novel liquid mixture according to embodiments herein.

In one embodiment, the electronic device 185-3 is a parallel plate capacitor including plate 711 and plate 712. A first capacitor conductor 711 having an electrical terminal is deposited on the substrate. The liquid BST ink is then printed or otherwise deposited (which may take multiple layers) by any convenient method on the first capacitor conductor 711. The liquid BST ink is cured by heating to a temperature of approximately 150 to 200° C. A second capacitor conductor 712 having an electrical terminal is deposited on the cured BST ink. The cured BST ink provides a thickness representing the distance between the two parallel plate capacitor conductors 711 and 712.

Thus, further embodiments herein include an apparatus (such as hardware, device, etc.) comprising: an electronic device 185 being fabricated; and a mixture 152 (such as a compound) applied to fabricate the electronic device 185. As previously discussed, the mixture 152 (compound) includes: i) perovskite oxide particles, and ii) a solvent, the solvent being a water-soluble liquid.

In accordance with further embodiments, the apparatus includes a substrate (such as plate 711) on which the liquid material (mixture 152) is initially applied. Mixture 152 disposed on plate 711 cures into dielectric material 750. A second plate is formed on the dielectric material 750.

In one embodiment, the substrate (such as plate 711 or material layer beneath plate 711) is electrically conductive structure (such as metal) coupled to a first reference voltage. Plate 712 is an electrically conductive structure (such as metal) coupled to a second voltage reference.

In one embodiment, the mixture 152 has a curing temperature at or below 170 degrees Celsius. The curing temperature may vary depending on the embodiment. Based on the composition of the mixture used to fabricate electronic device 185-3, the dielectric constant of the cured dielectric material is substantially constant for application of frequencies between 2 GHz and 12 GHz.

In accordance with yet further embodiments, note that the substrate or base material on which the mixture 152 is applied for curing can be any suitable material. For example, as previously discussed, in one embodiment, the substrate on which the mixture 152 is applied is a material such as metal, dielectric material, plastic, etc.

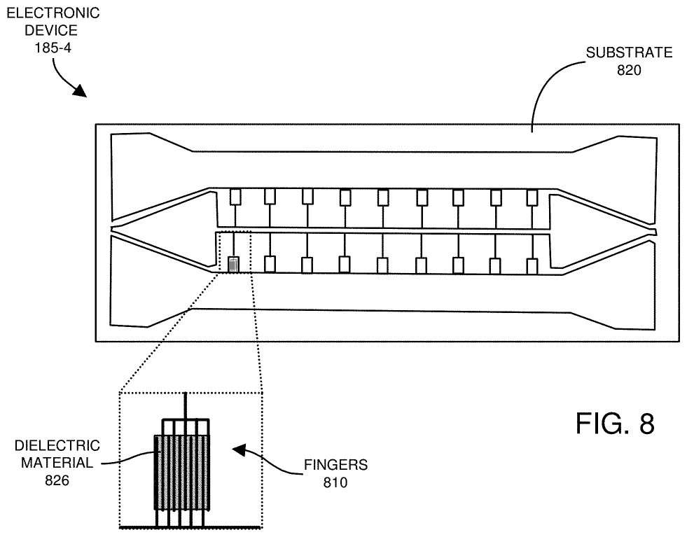

FIG. 8 is an example diagram illustrating fabrication of an electronic device using a novel mixture according to embodiments herein.

In this example embodiment, the fabrication system 155 uses mixture 152 to fabricate electronic device 185-3. For example, the fabrication system 155 dispenses the mixture 152 between interdigitated finger 810 to fabricate device 185-4. Subsequent to curing of the mixture 152 into respective dielectric material 826, application of an electric field to the dielectric material 826 between the fingers 810 changes the dielectric constant value of the corresponding dielectric material and a respective capacitance of the fingers. Via changing of the electric field applied to the dielectric material 826 between the fingers 810, one is able to frequency tune operation of the corresponding electronic device 185-4.

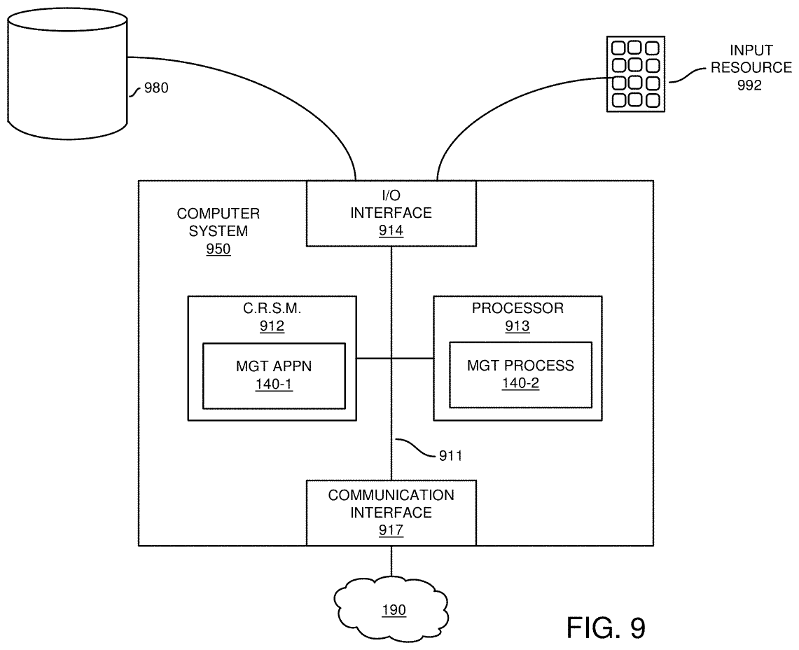

FIG. 9 is an example block diagram of a computer system for implementing any of the operations as discussed herein according to embodiments herein.

Any of the resources (such as control system, fabrication system, etc.) as discussed herein can be configured to include a processor and executable instructions to carry out the different operations as discussed herein.

As shown, computer system 950 (such as operated by a respective fabricator or fabrication facility) of the present example can include an interconnect 911 that couples computer readable storage media 912 such as a non-transitory type of media (i.e., any type of hardware storage medium) in which digital information can be stored and retrieved, a processor 913, I/O interface 914, and a communications interface 917. I/O interface 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with fabrication management application 140-1 (e.g., including instructions) to carry out any of the operations as discussed herein.

During operation of one embodiment, processor 913 accesses computer readable storage media 912 via the use of interconnect 911 in order to launch, run, execute, interpret or otherwise perform the instructions in fabrication management application 140-1 stored on computer readable storage medium 912. Execution of the fabrication management application 140-1 produces fabrication management process 140-2 to carry out any of the operations and/or processes as discussed herein.

Those skilled in the art will understand that the computer system 950 can include other processes and/or software and hardware components, such as an operating system that controls allocation and use of hardware resources to fabrication management application 140-1.

In accordance with different embodiments, note that computer system may be or included in any of various types of devices, including, but not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

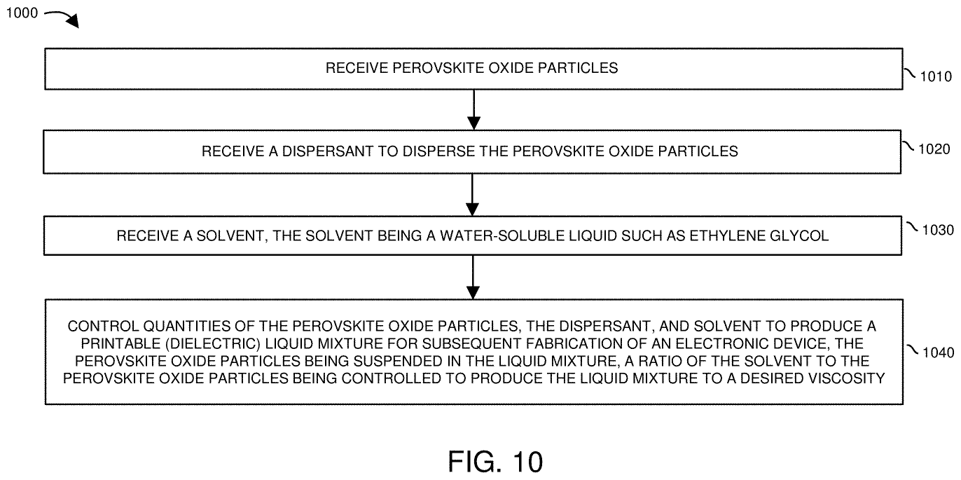

Functionality supported by the different resources will now be discussed via flowcharts in FIG. 10. Note that the steps in the flowcharts below can be executed in any suitable order.

FIG. 10 is a flowchart 1000 illustrating an example method according to embodiments. Note that there will be some overlap with respect to concepts as discussed above.

In processing operation 1010, a control system 140 (such as executing the control application 140-1) receives perovskite oxide particles 130.

In processing operation 1020, the control system 140 receives a dispersant 105.

In processing operation 1030, the control system 140 receives one or more solvents such as solvent 111, 112, 113, and 114. In one embodiment, at least one of the solvents such as solvent 111 is a water-soluble liquid such as ethylene glycol.

In processing operation 1040, in accordance with the control information 141 and 146, the control system 140 controls a ratio of mixing quantities of the perovskite oxide particles 130, the dispersant 105, and the solvents 111, 112, 113, and 114 to produce a printable (dielectric) liquid mixture 152 for subsequent fabrication of an electronic device 185. The perovskite oxide particles 130 are suspended in the liquid mixture 152; the dispersant 105 disperses the perovskite oxide particles 130 in the liquid mixture 152. The control system 140 controls a ratio of the solvents and the perovskite oxide particles 130 included in the liquid mixture 152 to achieve a desired viscosity, which may vary depending on the application.

Note again that techniques as discussed herein are well suited to manufacture printable liquid (dielectric material) that cures into solid dielectric material for electronic device fabrication. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A compound comprising:
perovskite oxide particles;
a solvent, the solvent being a water-soluble liquid; and
a combination of the perovskite oxide particles and the solvent being combined to produce a liquid mixture for subsequent fabrication of an electronic device.

2. The compound as in claim 1, wherein the perovskite oxide particles are suspended in the solvent.

3. The mixture as in claim 1, wherein the solvent is Ethylene Glycol.

4. The mixture as in claim 1, wherein a ratio of the solvent to the perovskite oxide particles is controlled such that the mixture has a viscosity of 20 and 6000 cP.

5. The mixture as in claim 1 further comprising:
a dispersant operable to disperse the perovskite oxide particles in the mixture.

6. The mixture as in claim 5, wherein the dispersant includes Ammonium Polymethacrylate.

7. The mixture as in claim 1 further comprising:
a water-soluble polymer material.

8. The mixture as in claim 7, wherein the water-soluble polymer material is polyvinyl alcohol and/or polyvinylpyrrolidone.

9. The mixture as in claim 1 further comprising:
a polymer dissolvable in nonaqueous solvents.

10. The mixture as in claim 1, wherein the perovskite oxide particles are doped Barium Strontium Titanate (BST) particles.

11. The mixture as in claim 1, wherein polyvinyl alcohol material is absent from the mixture; and
wherein the combination includes: a mixture of ethylene glycol and 1-methoxy-2-propanol, a ratio of the mixture adjusted to control viscosity of the solvent mixture.

12. The mixture as in claim 1, wherein the combination includes:
a PVA (PolyVinyl Alcohol) material;
a mixture of ethylene glycol and water, a ratio of the ethylene glycol to water adjusted to control viscosity.

13. The mixture as in claim 1, wherein the solvent is selected from the glycol family of solvents.

14. The mixture as in claim 1, wherein the solvent is a first solvent; and
wherein the combination further includes a second solvent.

15. The mixture as in claim 14, wherein the second solvent is a type of glycol ether.

16. The mixture as in claim 14, wherein the second solvent is a water-soluble polymer material dissolved in water.

17. A method comprising:
receiving perovskite oxide particles;
receiving a solvent, the solvent being a water-soluble liquid; and
producing a liquid mixture including the perovskite oxide particles and the solvent for subsequent fabrication of an electronic device.

18. The method as in claim 17, wherein the perovskite oxide particles are suspended in the liquid mixture.

19. The method as in claim 17, wherein the solvent is Ethylene Glycol.

20. The method as in claim 17, wherein mixing the combination includes:
controlling a ratio of the solvent to the perovskite oxide particles in the liquid mixture such that a viscosity of the liquid mixture is 20 and 6000 cP.

21-37. (canceled)
